(19) United States
(12) Patent Application Publication
(10) Pub. No.: US 2005/0073119 A1
(43) Pub. Date: Apr. 7, 2005

(54) Portable organizer with multiple storage trays

(76) Inventor: Murat Kirakosyan, Hacienda Heights, CA (US)

Correspondence Address: Harold L. Jackson;Jackson Law Corporation, Ste. N, 14751 Plaza Dr., Tustin, CA, 92780, US

(21) Appl. No.: 10/676,595

(22) Filed: Oct. 1, 2003

(51) Int. Cl. B62B 1/00

(52) U.S. Cl. 280/47.26

(57) ABSTRACT

A portable organizer, with multiple removable storage trays for receiving parts during the disassembly of a piece of apparatus, includes a rectangular frame with opposing side walls, a top, base, front and rear. A number of U-shaped trays are pivotally mounted to the frame side walls and coupled together to pivot in unison via a gang bar slidably mounted on the frame. The trays have an open top which is generally parallel to the frame front in a deployed position and inclined in a retracted position in which parts stored therein are readily accessible. The individual trays may be removed from the frame and placed near the disassembly site and then reinstalled in the frame for storage until the parts are required during the reassembly process.

### FIELD OF THE INVENTION

The present invention relates to a parts organizer and more particularly to a portable universal organizer for enabling a user such as a mechanic to organize and temporarily store parts of a vehicle component such as bolts, nuts, washers, etc. resulting from the disassembly of vehicle component, a transmission, engine, brake unit etc.

### BACKGROUND OF THE INVENTION

During the disassembly of a vehicle component such as a brake unit, transmission, engine, etc. mechanics typically place the small disassembled parts, such as bolts, nuts, cotter pins, lock washers, snap washers, set screws etc. on a work bench, nearby floor space, in pans or other containers. Such a procedure, while perhaps expedient from the standpoint of the disassembly procedure can turn into a time consuming and even expensive process where essential parts are misplaced or lost. Various types of organizers and storage containers have been suggested in the prior art.

See, for example, U.S. patent No. US/2002/0040880A1 (“'880 publication”) which discloses an organizer in which a plurality of bins with an open front are pivotally mounted in a housing for simultaneous rotation between an open and closed position by means of a strap or bar (5). While the '880 publication would aid a user in placing and keeping the removed parts in specific bins, it suffers from several disadvantages. The individual bins cannot be removed from and reinstalled in the housing. Thus, a user, such as a mechanic, could not take one of the bins and position it adjacent the site where the disassembly process is taking place. For example, a mechanic may be positioned under a vehicle or over the engine compartment while removing a particular assembly or component. It would be advantageous for the mechanic to be able to place the dismantled parts into one or more separate containers located close to the working area and then be able to access the container(s) at a later time when the component is to be reassembled. In addition, the items in the bins of the '880 publication are not readily viewable when the bins are in the closed position.

U.S. Pat. No. 5,458,409 (“'409 patent”) like the '880 publication discloses a storage container with drawers which are arranged to pivot in unison from an open to a closed position. The drawers are not removable and in the closed position would not allow a user to see the contents in the drawer. In addition, it does not appear that the container would be readily moved from one location to another. Also see U.S. Pat. Nos. 4,616,891 and 4,822,119 for similar types of storage compartments.

U.S. Pat. No. 3,942,851 (“'851 patent”) discloses a storage bin assembly in which individual bins are pivoted on a rod so that the bins are oriented horizontally when empty and oriented at angle to the horizontal when supporting articles. While the bins can be lifted off their respective support rods they are not arranged to pivot in unison and permit the contents to be viewed only when the individual bins are tipped downwardly.

Conventional storage cabinets are designed to contain loose items of different types such as tools, spare parts and the like. While objects according to type may be stored in individual compartments it may require a considerable time to search through the many compartments to find the particular item(s) the searcher is looking for. In addition, the housing for such compartments are generally not readily portable, and where portable, such as a mechanics tool cabinet, the individual drawers are not readily removable.

There is a need for a more user friendly organizer which will enable a user such as a mechanic to temporarily store small parts removed during the disassembly of an apparatus and readily retrieve such parts during the reassembly process.

### SUMMARY OF THE INVENTION

A generally rectangular frame member having opposing side walls, a top, base, front and rear, houses a plurality of generally U-shaped tray members. Each tray member has an open top lying in a plane and is releasably mounted to the side walls of the tray so that the tray members are arranged in a vertical arrangement for rotation between a deployed position in which the plane of the open tops are generally parallel to the frame front and a retracted position in which the planes of the open tops extend at an acute angle to the frame front, for example, at an angle within the range of 15° to 65° and most preferably about 25° to 45° to the horizontal. A gang bar, slidably mounted on the frame, is coupled to the individual tray members so that the tray members, when positioned on the frame, will move in unison from the retracted to the deployed position and visa versa. The mounting between the individual tray members and the coupling between the gang bar and the tray members allow one or more of the tray members to be removed from the frame and placed near the site where an apparatus is being disassembled and then replaced in the frame after receiving the disassembled parts to be temporarily stored.

The frame with the trays mounted therein, which normally rests on its base in a vertical position, can be laid on the floor near the disassembled site so that the tops of the trays are oriented vertically to receive the disassembled parts or tilted at a small angle to the horizontal by allowing a handle, pivotally mounted to the top of the frame, to support the frame top with respect to the floor. The front, bottom and back walls of the trays may be made of perforated material such as metal to allow the parts within a tray to be cleaned by a suitable solvent. The top of the front and back walls of the trays may be rolled over to provide a rounded top edge to eliminate a sharp edge and the front and back edges may include opposing spaced notches for retaining dividers in place within the trays. The frame may optionally be provided with wheels attached to the base and the top may include a shelf provided with spaced openings for receiving spark plugs and the like.

The present invention, both as to its construction and operation, may best be understood by reference to the following description taken in conjunction with the accompanying drawings.

### BRIEF DESCRIPTION OF THE DRAWINGS

FIG. 1 is a perspective view of a portable organizer in accordance with the present invention with the trays in the retracted position and one of the trays removed and positioned in front;

FIG. 2 is a side view of the organizer with the trays in the deployed position and without the can holder;

FIG. 3 is a front view of the organizer of FIG. 2;

FIG. 4 is a side view of the organizer with the trays in the retracted position;

FIG. 5 is a front view of the organizer of FIG. 4;

FIG. 6 is a back view of the organizer of FIG. 2 with the trays removed showing the gang bar member for controlling the rotation of the trays, the collapsible handle arrangement and J hooks for enabling the organizer to be supported on a cart, etc.;

FIG. 7 is a side view of the organizer in a reclined position on a floor with the top of the frame supported on the floor by the handle and without the trays installed therein;

FIG. 8 is a side view of the organizer of FIG. 7 laying on the floor;

FIG. 9 is a top plan view of a tray with two dividers inserted therein;

FIG. 10 is an end view of a divider; and

FIG. 11 is a perspective view of a tray made of perforated material with two dividers inserted therein.

### DESCRIPTION OF THE PREFERRED EMBODIMENT

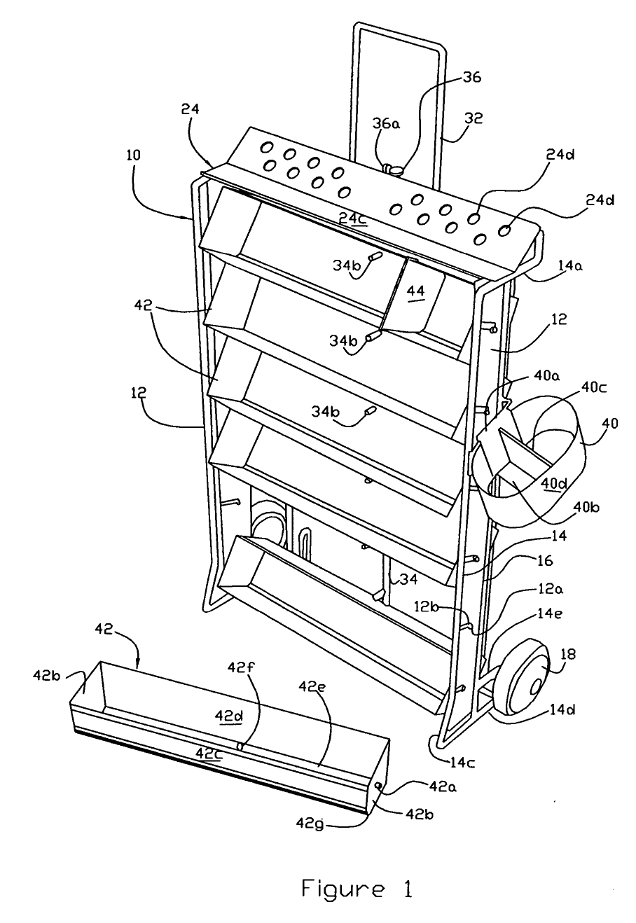

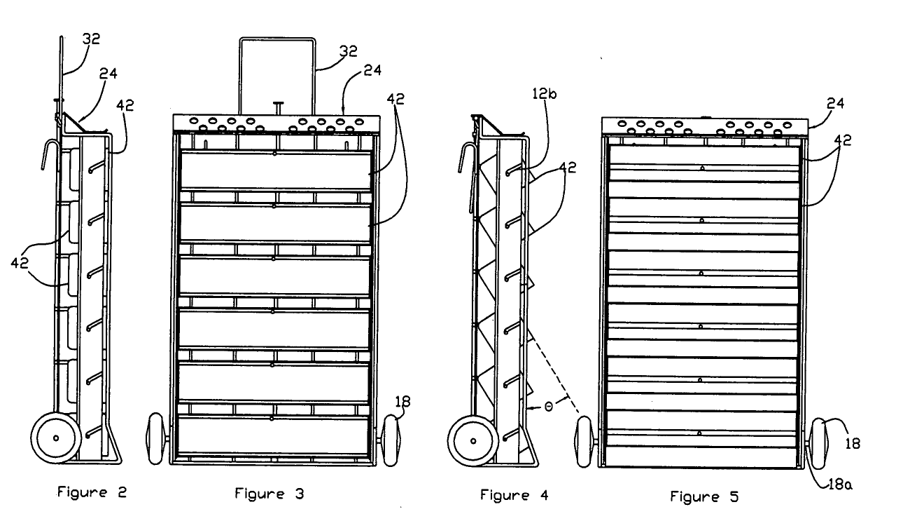

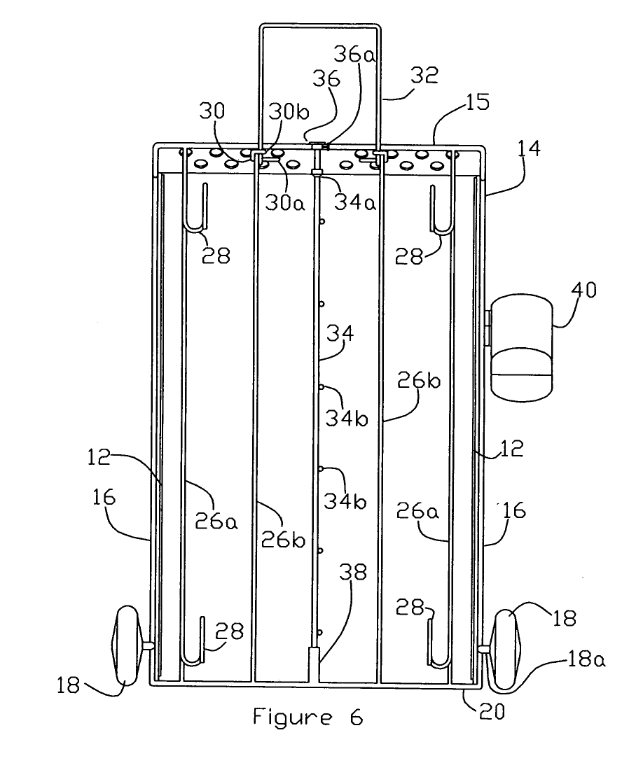

Referring now to the drawings and particularly to FIGS. 1-6, an organizer in accordance with the present invention includes a frame 10 which supports a plurality of trays 42. The frame has lateral side walls 12 secured between support rods 14 and 16 with the rods 14. The forward rods 16 extend rearwardly at the top along section 14a then upwardly along section 14b and thence are joined together via top horizontal rod 15. The lower ends of the rods 14 are slanted forwardly along section 14c and then rearwardly along base section 14d to form a bracket to support axles 18a of wheels 18. The bracket includes an upper section 14e which is joined to the rod 16 as shown. A lower horizontal rod 20 extends between sections 14d to form, along with sections 14d, the base of the frame as is shown in FIG. 6. Additional rear support rods 22 extend vertically from the rod 20 to the top rod 15. A top shelf 24 is secured to and supported by the rod sections 14a and the rod 15 as shown. The slanted portion 24a of the shelf 24 is provided with openings or apertures 24b for receiving and supporting spark plugs and the like. The horizontal section 24c of the shelf may be used to support tools or miscellaneous items.

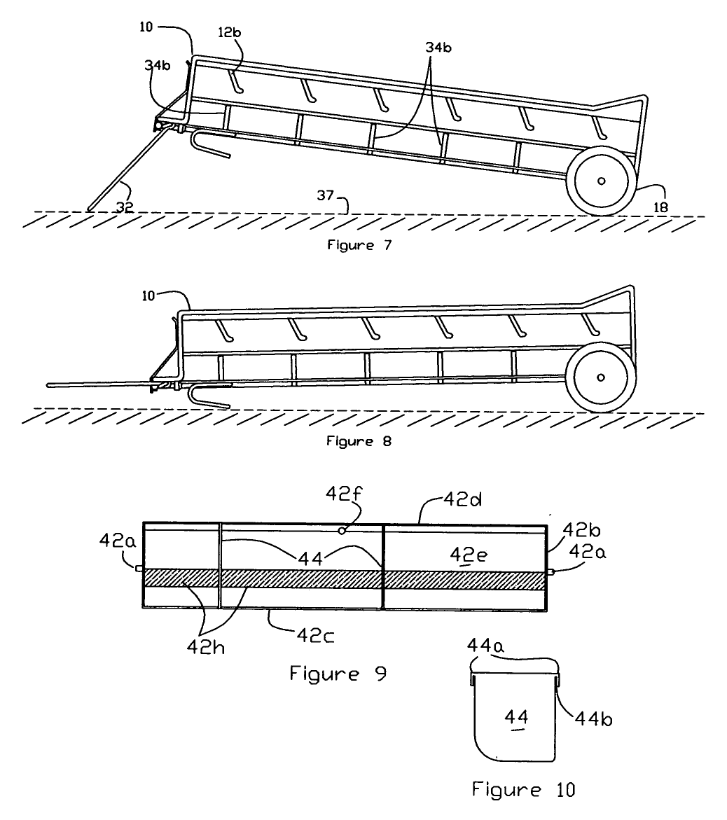

Vertically extending rear rods 26a and 26b are joined to the top and bottom rods 15 and 20, respectively, to form the rear of the frame. The outer rods 26a support two top and bottom J-hooks 28 to enable the frame to be supported on the side of a cart such as a mechanics wheeled cart or a work bench. Horizontally oriented J-shaped handle supports 30 are secured to the upper ends of the rods 26b with their inwardly extending lower stubs 30a arranged to pivotally mount a foldable rectangular handle bar 32 via eyelets on the lower end of the bar 32. The handle 32 is held in an upright position via the inwardly extending upper stubs 36b as is shown in FIG. 6. The lower ends of the handle can be squeezed together to clear the inner surface of the stubs 30b and allow the handle to drop down. The handle may then be rotated to engage the outer surface of the stubs 30b to support the frame at an inclined position relative to a floor 37 as is illustrated in FIG. 7. Alternatively, the frame may be laid on the floor as is shown in FIG. 8.

A gang bar or rod 34 is slidably mounted to the central rear portion of the frame via a guide collar 36 secured to the rod 15 and blind bore in a post 38 secured to the base rod 20 as is shown in FIG. 6. The gang bar, pictured at rest in FIG. 7 (retracted position), is arranged to slide upwardly until a stop collar 34a (carried by the bar) engages the guide collar 36 (deployed position). Actuating pins 34b are secured to and extend horizontally inwardly from the gang bar. The actuating pins are arranged to project through cooperating openings or holes in individual trays releasably carried by the frame as will be described.

An adjustable can or cup holder 40 is secured to the rods 14 and 16 on one side of the frame via a plate 40a. The holder 40 includes a base 40b supporting a divider 40c and an adjustable peripheral wall 40d for accommodating different sized cans or containers.

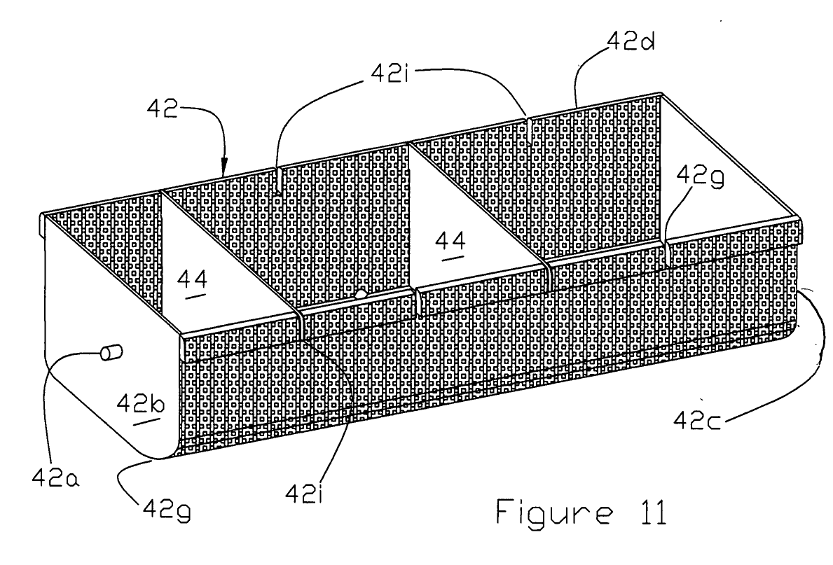

The trays 42 are releasably mounted in the frame via pivot pins or studs 42a which extend outwardly from opposed end walls 42b. The pivot pins 42a ride in recesses 12a at the terminal ends of inclined channels or slots 12b in the frame side walls 12. Referring now to FIGS. 1, 9 and 10, each tray is formed with a front wall 42c, a back wall 42d, bottom wall 42e and an opening 42f in the center of the bottom wall adjacent the back wall as shown. The junction 42g between the front and bottom walls is preferably rounded as is shown in FIGS. 1 and 11 to aid a user in the retrieval of parts disposed in the tray. The junction of the bottom and back walls preferably form about a 90° angle. The openings 42f receive the actuating pins 34b. The upper or free edge of the front, back and end walls of the tray form an open top of the tray, the perimeter of which lies in a plane that is generally parallel to the front of the frame when the trays are in the deployed position as is illustrated in FIGS. 1-3. The trays pivot relative to the recesses 12a about an imaginary axis extending through the pivot pins 42a when mounted in the frame through an angle ⊖, with respect to the vertical as illustrated in FIG. 4 from a deployed position (⊖≅0°) to a retracted position (⊖≅15° to 65°). In the retracted position ⊖ preferably equals about 25° to 45°. The trays pivot in unison as a result of the pin 34b/opening 42f coupling between the gang bar and the trays. The center of gravity of the unloaded trays extends slightly below the imaginary pivot axis. As a result when the organizer is raised from a reclined position, such as that shown in FIG. 7 (or flat position FIG. 8), to vertical position, such as that shown in FIG. 1, the trays will automatically rotate to their retracted position unless a set screw 36a, carried by guide collar 36, is tightened to prevent movement of the gang bar 34.

The trays may be made of any suitable material, but preferably are made of sheet metal such as steel. While the front, bottom and back walls may be solid as shown in FIG. 1 they are preferably perforated as is illustrated in FIG. 11. The perforations allow parts contained in the tray to be cleaned with a suitable solvent by either dipping the trays in the solvent container or by pouring solvent onto the parts in the tray and allowing the solvent to drain through the holes to a recovery vessel. The trays after being constructed are preferably provided with a yellow zinc coating in a conventional manner for rust and solvent resistance purposes. It should be noted that the bottom walls of the trays may be provided with a magnetic plate 42h (solid or perforated) as is illustrated in FIG. 8 to retain steel or ferrous alloy parts therein.

The upper (free) edges of the front and back walls of the trays are preferably rolled over in the form of an inverted U to provide a rounded edge. The top edge is also preferably notched at opposed locations 42i along the sides to receive the laterally extending shoulders 44a notched at 44b at the top of divider 44. The notches 42i and the slotted divider shoulders securely retain the channel free dividers in place to provide separate compartments within each tray as is illustrated in FIG. 11. The use of edge notches to secure the dividers in place leaves the inside of the tray free of obstructions.

The frame, with the trays therein in their deployed position, can be laid on a floor or other surface or inclined with respect thereto (FIGS. 7 and 8) near the disassembly area to facilitate the placement of parts in the trays. Alternatively, one or more of the trays 42 can be removed from the frame by disengaging the pivot pins and the openings 42f from the channels 12b and actuating pins 34b respectively. Once the trays are removed they can be placed adjacent the disassembly site to facilitate the placement of parts therein. The trays can then be replaced in the frame and accessed later when the parts are needed.

It is to be noted that in an alternative construction of a releasable mounting between the trays and the frame the pivot pins could protrude from the frame side walls and slide into inclined channels formed in the trays. In addition, the construction of the coupling between the gang bar and the individual trays could be reversed with actuating pins carried by the trays extending into openings in the gang bar.

By way of example only, the frame can be about 48″ in height, 17″ in width with a distance of about 15¼″ between the side walls. The individual trays can be about 15″ long, 3″ wide and 3″ deep.

There has thus been described a novel and user friendly parts organizer. Modifications and improvements to the organizer may occur to those skilled in the art without involving any departure from the spirit and scope of the invention as called for in the appended claims.

1. An organizer comprising:
a generally rectangular frame member having opposing side walls, a top, base, front and rear;
a plurality of generally U-shaped tray members, each tray member defining an open top lying generally in a plane, the tray members being releasably mounted to the side walls in a vertical array arrangement for rotation between a deployed position in which the planes of the open tops are generally parallel to the front of the frame and a retracted position in which the planes of the open tops extend at an acute angle to the front of the frame; and
a gang bar member slidably mounted on the frame and releasably coupled to the tray members so that the tray members when positioned in the frame will move in unison from the retracted to the deployed position and visa versa, the mounting between the individual tray members and the coupling between the gang bar and the individual tray members allowing one or more of the tray members to be removed and from or installed in the frame.

2. The organizer of claim 1 wherein the releasable mounting between the frame member and the tray members comprises a pair of pivot pins associated with each tray member secured to one of the frame and tray members and a pair of cooperating inclined channels associated with each tray member located on the other of said members.

3. The organizer of claim 2 wherein the coupling between the gang bar member and each of the individual tray members comprises an actuating pin locaed on one of the gang bar and tray members and a cooperating pin receptacle on the other of said members whereby when the gang bar is moved in one direction the tray members are rotated from the retracted to the deployed position and visa versa.

4. The organizer of claim 3 wherein the releasable mounting between the frame and the tray members comprises a pair of oppositely disposed inclined channels on the side walls of the frame for each tray member, each of the channels terminating in a pin receiving recess with the pin receiving recesses of each pair of channels associated with a respective tray member aligned along a horizontal pivot axis and cooperating pivot pins secured to each end walls of the tray members.

5. The organizer of claim 4 wherein the center of gravity of each of the trays is located below the respective pivot axis whereby the trays will rotate automatically to their retracted position when the frame is moved from a horizontal to a vertical position.

6. The organizer of claim 5 wherein each tray is elongated with front, back and bottom walls joined to opposed end walls and wherein the free edges of the front and back and end walls define the perimeter of the tray open top, with the perimeter lying substantially in a plane.

7. The organizer of claim 6 wherein the base of the frame is arranged to support the frame in a generally vertical position.

8. The organizer of claim 7 further including at least one pair of hooks secured to the frame for allowing the frame to be secured to a cart.

9. The organizer of claim 8 wherein said at least one pair of hooks comprises two pair of hooks with one pair being located adjacent the top of the frame and the other pair being located adjacent the base of the frame.

10. The organizer of claim 6 wherein the front, bottom and back walls of at least one of the trays are perforated.

11. The organizer of claim 6 wherein the front, bottom and back walls of at lease one of the trays is solid.

12. The organizer of claim 7 wherein the junction of the front and bottom walls of the trays form a rounded corner.

13. An organizer comprising:
a rectangular frame having opposing side walls, a top, base, front and rear sections, the side walls defining a plurality of upwardly inclined slots open at the front of the frame and vertically spaced with each pair of opposing slots terminating in pin receiving recesses, the respective recesses being aligned along a separate horizontal pivot axis;
a plurality of generally U-shaped elongated tray members having front, bottom, back and opposed end walls, the free edges of the front, back and opposed end walls defining an open top with a pivot pin mounted on each end wall, the pivot pins being positioned within the recesses in the frame side walls so that each tray is arranged to pivot about a respective horizontal axis; and
a gang bar member slidably mounted on the frame and coupled to each tray via a releasable coupling to allow the pivot pins of individual trays to be slidably removed from the recesses and associated angular slots and for causing trays mounted in the frame to pivot in unison when the bar is moved relative to the frame.

14. The organizer of claim 13 wherein the gang bar is aligned parallel to the frame side walls.

15. The organizer of claim 13 wherein the gang bar is slidably mounted on the rear center of the frame.

16. The organizer of claim 13 wherein the releasably coupling between the gang bar and the individual trays comprises protruding pins on the gang bar member or the tray members and a cooperating openings in said other member, the pin and cooperating opening permitting each individual tray to be removed from or installed in the frame.

17. The organizer of claim 16 wherein the tray members include a back wall and wherein the releasable coupling between the gang bar and the trays comprises a plurality of vertically spaced protruding pins carried by the gang bar and cooperating openings in the bottom wall of the tray members.

18. The organizer of claim 17 in which the open tops of the trays lie in a plane and wherein the trays when mounted in the frame are arranged to pivot between a deployed position in which the plane of the open tops is generally parallel to the frame front and a retracted position in which the plane of the open tops is at an angle of ⊖ of about 15° to 65° to the frame front.

19. The organizer of claim 18 wherein the front and back walls of the trays form free edges with opposed spaced slots therein and further including dividers located in one or more of the opposed slots, the dividers being locked to the free edges and extending to the bottom wall of the respective trays, the inside surface of the trays being unobstructed absent the presence of the dividers.

20. The organizer of claim 18 wherein the front, bottom and back walls of the trays are solid.

21. The organizer of claim 18 wherein the front, bottom and rear walls of the tray are perforated.

22. The organizer of claim 18 wherein the top of the frame includes a stationary shelf with circular openings for accommodating the receipt of spark plugs.

23. The organizer of claim 18 further including a magnetic plate secured to the bottom wall of one or more of the trays.

24. The organizer of claim 18 wherein the walls of the tray are provided with a yellow zinc coating.

25. The organizer of claim 18 wherein the junctions of the trays' front and bottom walls are rounded and the junction of the bottom of back walls of the trays form about a 90° angle.
